(19) United States
(12) Patent Application Publication
(10) Pub. No.: US 2008/0020161 A1
(43) Pub. Date: Jan. 24, 2008

(54) Antistatic Dissipative Flexible Intermediate Bulk Container

(76) Inventors: Shimon Shacham, Kfar-Tavor (IL); John Lewis Goldbart, Kibbutz Naot Mordechai (IL); Jacob Soker, Kfar-Vradim (IL)

Correspondence Address: PEARL COHEN ZEDEK LATZER, LLP, 1500 BROADWAY 12TH FLOOR, NEW YORK, NY, 10036, US

(21) Appl. No.: 10/594,329

(22) PCT Filed: Jan. 9, 2005
(86) PCT No.: PCT/IL05/00029

§ 371 Date: Jul. 12, 2007

Related U.S. Application Data
(60) Provisional application No. 60/558,100, filed on Apr. 1, 2004.

(51) Int. Cl. B65D 30/04; B32B 27/02; B32B 27/04; B32B 27/12; B65D 30/26; B65D 30/06; B32B 27/32; B32B 5/08

(52) U.S. Cl. 428/36.1

(57) ABSTRACT

A flexible intermediate bulk container, comprising a flexible bag made of an antistatic fabric comprising electrically non-conducting warp and weft yarns and a plurality of conductive dissipative fibers intersectingly woven into the antistatic fabric. The conductive dissipative fibers comprise Polyolefine with a Polyether-Block-Polyolefine-Copolymer additive. The Polyether-Block-Polyolefine-Copolymer comprises connected or nearly-connected conductive channels at, or near, external surface of the fibers, and wherein the bag is provided with an antistatic dissipative membrane. The bag may be grounded or ungrounded and exhibit corona discharge.

### FIELD OF THE INVENTION

The present invention relates to an antistatic dissipative flexible intermediate bulk containers.

### BACKGROUND OF THE INVENTION

Flexible intermediate bulk containers (FIBCs) are widely used in industry and agriculture. As an FIBC is filled or discharged, electrostatic charging may occur. This is a very risky phenomenon, as inadvertent electrostatic discharge could cause a catastrophe.

The present invention applies to FIBCs requiring means for preventing inadvertent electrostatic discharge.

An example of the type of container to which the present invention is aimed are Type “D” FIBCs, which are required by CENELEC—the European committee for electrotechnical standardization—to have means for preventing inadvertent electrostatic discharge by inducing corona discharge.

Type D FIBCs have the advantage over Type C FIBCs in that Type D FIBCs are not required to be grounded whereas Type C are. However, this advantage is significantly nullified by the requirement to ground conductive elements in the immediate vicinity of the Type D FIBC to prevent inductive charging of the elements.

In the past, most antistatic ingredients worked on the surface of the FIBC fabric and were impermanent—the antistatic agents would easily migrate into the surroundings.

The present invention eases this limitation, reducing the inductive charging of the conductive elements in the vicinity of the FIBC so much that in many applications there is no need to ground the conductive elements.

CENELEC has recently included Type D in the latest code of practice to be published in Europe: CLC TR 50404: 2003 “Electrostatics-Code of practice for avoidance of hazards due to static electricity.”

The CENELEC code of practice does not actual classify “groundable Type D”. As the authors note there: “Earthing (of FIBC type D) has only a minor effect on charge dissipation and is not required”.

The authors continue on the other hand: “Earthing of all objects and personnel in the surroundings is required.” The conventional approach is to require grounding for all conductive parts that are closer than 1 meter from the FIBC.

The inventor of the present invention is aware of several manufacturers that relate to Type D FIBC.

One manufacturer is LINQ (U.S. Pat. Nos. 5,478,154; 5,679,449; and 6,112,772) whose container is based on fiber comprised of quasi-conductive metalized fibers, which are not interconnected. The quasi-conductive fiber is based on a conductive core, which is surrounded by nonconductive filament. Weak corona discharge gradually occurs on the fiber, so that grounding is not required.

However, conductivity in the fabric remains great enough that spark generation can occur upon contact with a large downward sinking charge.

Another disadvantage is that the fiber is difficult to manufacture and is subject to mechanical wear.

A further disadvantage is that the fiber's cross-section is non-standard, leading to further problems in manufacture of containers.

Yet another disadvantage is that for reasons of durability and manufacturability, the diameter of the fiber is larger than the desired diameter for optimum corona discharge over its length.

Another manufacturer is EUREA (U.S. Pat. No. 6,572,942), whose container is based on permanent antistatic threads, which are interconnected and woven to form a fabric. The antistatic agent used by EUREA is described in WIPO/PCT publication number WO 96/09629 (U.S. Pat. No. 5,759,649) and comprises an antistatic web of microcrystalline pins. See also US 20030099796 (Levi), relating to another manufacturer (SUNJUT).

A limitation of the EUREA patent is that it is limited to the aforementioned antistatic agent penetrated by an antistatic web of microcrystalline pins.

Another limitation is that their FIBC does not reduce induced energy on surrounding objects enough that those objects do not have to be grounded.

Another limitation is that the antistatic agent is distributed throughout the thickness of the thread, which reduces the antistatic effect.

Another limitation is for a good corona discharge, they require either the addition of pin-shaped metal particles or that the antistatic threads have a substantially round cross-section and be very thin.

Yet another manufacturer is UNSA (see US 20040076791 (Akdogan et al.)), who suggests using a woven fabric of plastic film where the surface of the woven fabric or plastics film at least partially comprising fibers protruding less than 10 mm from the surface. The embodiment disclosed in the specification of that patent specifically refers to chenille yarns. The UNSA specification mentions corona discharge of static electricity accumulating in the FIBC without going into much detail.

A limitation of the UNSA patent is the need for a special manufacturing of the fibers and incorporation with the fabric is not standard.

The present invention provides a fabric for a novel FIBC that prevents inadvertent electrostatic discharge by inducing corona dissipation and that can be grounded.

The fabric of the present invention comprises fibers of a novel antistatic dissipative ingredient that provides moderate surface conductivity. The fiber comprises balls of copolymer that are elongated during the drawing of the fiber to form connected and nearly-connected conductive channels. This is a completely new type of fabric and has nothing structurally in common with the EUREA patent: the new fabric has no matrix of microcrystalline pins.

Another innovation and advantage of the fabric is that the location of the channels can be controlled during manufacture of the fiber, such that the channels can be located in a layer at or near the surface of the fiber. This provides efficient corona discharge with no need for added metal or special thread geometry.

The fabric of the present invention is coated with the same novel antistatic dissipative ingredient thereby improving the connection between the channels and the dissipation.

When a FIBC constructed of the fabric is grounded, its charge is dissipated very quickly. When the FIBC is ungrounded, the fabric's corona discharge prevents spark discharges. Such a FIBC qualifies for the designation “D plus” (“D+”), as defined by the Swiss Institute for Safety and Security (SISS).

According to the SISS: “If an ungrounded FIBC Type D plus meets the same requirements as FIBC Type D, it can be used in hazard zone 1 when all conductive objects within 1 m around the FIBC are grounded.”

“If grounded (via lifting loops), FIBC Type D plus, can be used in hazard zone 1 like a FIBC Type C and with no further restrictions.”

The fabric of the present invention exhibits no, or very low, risk of incentive sparks to objects and personnel in the surroundings even if they are not grounded at all.

An ungrounded FIBC constructed of the fabric of the present invention can be used as a Type D bag and its induced charge on objects and personnel in the surroundings is very small compared to other Type D bags currently available.

In summary, it is a main object of the present invention to provide a fabric comprising nearly-connected conductive channels and exhibiting moderate corona discharge.

It is another main object of the present invention to provide such a fabric wherein the conductive channels are distributed on, or just below, the surface of the fabric.

It is another main object of the present invention to provide a FIBC manufactured of such a fabric, the FIBC being safe for use in explosion and fire hazard zones and useable grounded or ungrounded.

It is another main object of the present invention to provide a Type D plus FIBC according to the definition of the SSIS.

### BRIEF DESCRIPTION OF THE INVENTION

There is thus provided in accordance with a preferred embodiment of the present invention, a flexible intermediate bulk container, comprising a flexible bag made of an antistatic fabric comprising electrically non-conducting warp and weft yarns and a plurality of conductive dissipative fibers intersectingly woven into the antistatic fabric, wherein the conductive dissipative fibers comprise Polyolefine with a Polyether-Block-Polyolefine-Copolymer additive, the Polyether-Block-Polyolefine-Copolymer comprising connected or nearly-connected conductive channels at, or near, external surface of the fibers, and wherein the bag is provided with an antistatic dissipative membrane, whereby the bag may be grounded or ungrounded and exhibit corona discharge.

Furthermore, in accordance with another preferred embodiment of the present invention, the Polyether-Block-Polyolefine-Copolymer is mixed into the Polyolefine of the conductive dissipative fibers at a mass portion of 5% to 25%.

Furthermore, in accordance with another preferred embodiment of the present invention, at least some of the conductive dissipative fibers have a substantially rectangular cross-section.

Furthermore, in accordance with another preferred embodiment of the present invention, at least some of the conductive dissipative fibers have a substantially round cross-section.

Furthermore, in accordance with another preferred embodiment of the present invention, at least some of the conductive dissipative fibers are monofilament.

Furthermore, in accordance with another preferred embodiment of the present invention, at least some of the conductive dissipative fibers are multifilament.

Furthermore, in accordance with another preferred embodiment of the present invention, the membrane comprises a coating.

Furthermore, in accordance with another preferred embodiment of the present invention, the coating comprises Polyolefine with a Polyether-Block-Polyolefine-Copolymer additive.

Furthermore, in accordance with another preferred embodiment of the present invention, the membrane comprises an antistatic liner provided within the bag.

Furthermore, in accordance with another preferred embodiment of the present invention, the antistatic liner comprises Polyolefine with a Polyether-Block-Polyolefine-Copolymer additive.

Furthermore, in accordance with another preferred embodiment of the present invention, the membrane is inside the bag.

Furthermore, in accordance with another preferred embodiment of the present invention, the at least some conductive dissipative fibers are aligned with the weft.

Furthermore, in accordance with another preferred embodiment of the present invention, the distance between at least some conductive dissipative fibers is between 20 mm and 300 mm.

Furthermore, in accordance with another preferred embodiment of the present invention, distance is between 30 mm to 45 mm.

Furthermore, in accordance with another preferred embodiment of the present invention, the at least some conductive dissipative fibers are aligned with the warp.

Furthermore, in accordance with another preferred embodiment of the present invention, the distance between said at least some conductive dissipative fibers is between 20 mm and 300 mm.

Furthermore, in accordance with another preferred embodiment of the present invention, the distance is between 30 mm to 45 mm.

Furthermore, in accordance with another preferred embodiment of the present invention, lifting straps are attached to the bag.

Furthermore, in accordance with another preferred embodiment of the present invention, the lifting straps are conductively attached to the bag.

Furthermore, in accordance with another preferred embodiment of the present invention, the lifting straps comprise electrically non-conducting warp and weft yarns and a plurality of conductive dissipative fibers.

Furthermore, in accordance with another preferred embodiment of the present invention, the conductive dissipative fibers comprise Polyolefine with a Polyether-Block-Polyolefine-Copolymer additive.

Furthermore, in accordance with another preferred embodiment of the present invention, the conductive dissipative fibers are multifilament.

### BRIEF DESCRIPTION OF THE FIGURES

The invention is described herein, by way of example only, with reference to the accompanying Figures, in which like components are designated by like reference numerals.

FIG. 1 illustrates a fiber produced in accordance with the present invention.

FIG. 2 illustrates a section of a fabric manufactured according to a preferred embodiment of the present invention.

FIG. 3A illustrates a cross section view of a coated fabric manufactured according to a preferred embodiment of the present invention.

FIG. 3B illustrates a different cross section view of the coated fabric of FIG. 3B, showing the conductive bridge created by Polyether-Block-Polyolefine-Copolymer fibers from the grid to the coating.

FIG. 4A illustrates a lifting strap in accordance with a preferred embodiment of the present invention.

FIG. 4B illustrates a lifting strap in accordance with another preferred embodiment of the present invention.

FIG. 5A illustrates a cross-section of a substantially rectangular fiber in accordance with a preferred embodiment of the present invention.

FIG. 5B illustrates a cross-section of a substantially round fiber in accordance with a preferred embodiment of the present invention.

FIG. 5C illustrates in side view a multifilament fiber in accordance with a preferred embodiment of the present invention.

FIG. 6 illustrates a flexible intermediate bulk container in accordance with a preferred embodiment the present invention.

### DETAILED DESCRIPTION OF THE INVENTION

The present invention is an antistatic dissipative fabric suited for manufacturing a flexible intermediate bulk container (FIBC).

There is an electric field around any charged object. A conductor introduced into this field changes the distribution of potential in the field in its vicinity and causes separation of opposing charges within the conductor. If it is insulated from earth, the conductor takes up a potential depending upon its position in the field and it is said to be charged by induction. By virtue of its potential, coupled with the separated charges that it carries, the conductor can create an electrostatic spark.

If the conductor is momentarily earthed while it is in the field, its potential is reduced to zero but it acquires a net charge. The remaining charge can cause a spark when the insulated conductor is removed from the vicinity of the original charged object. This type of induction sparking can be hazardous, for example, when an insulated person moves about near electrostatically charged materials.

The present invention is based on an inherently dissipative polymer material: a Polyether-Block-Polyolefine-Copolymer (PBPC), which provides antistatic dissipative qualities to fiber used to weave fabric for FIBCs. The PBPC forms conductive channels at, or near, the surface of the fiber. The channels are interconnected by the grid of the fiber and also by an antistatic dissipative membrane layer, which can also comprise PBPC.

The PBPC is insoluble in Polyolefine. In a melt of Polyolefine (for example, Polypropylene, Polyethylene, a combination of both, or similar material) the PBPC forms isolated balls. If the proper concentration of PBPC is used, it will form a layer just below the surface of the Polyolefine melt. Typically this 5% to 25% of the mass of the Polyolefine.

During the extrusion process (particularly during the melt draw) and hot stretching of the film that produce fibers from the Polyolefine for the fabric of the container, the PBPC balls become elongated and coupled to produce single polymer strings. These strings form numerous connected and nearly-connected conductive channels at, or near, the surface of the Polyolefine.

The charge flowing along these strings jumps from one string to the other string where the distance is very small. The distances depend on the concentration of the PBPC in the Polyolefine and the level of orientation of the fiber.

The channels in addition to conductivity also provide corona discharge (antistatic effect). The corona discharge is substantially greater along the direction of extrusion (longitudinal direction of fiber) than it is across the direction of extrusion (transverse direction of fiber).

In the extruded end product (fiber) the PBPC is mainly concentrated in a layer at, or near, the surface of the fiber. The location of the layer can be controlled by the concentration of the PBPC in the Polyolefine and the processing temperature. Locating the layer in this place, gives the fiber high efficiency for both corona discharge and grounding.

The fabric of the present invention includes a membrane on its inner surface (the surface facing the contents of the FIBC). The membrane is antistatic and dissipative and can comprise a similar PBPC mixture to that used in the fabric. The membrane can be implemented in various ways known to those skilled in the art, for example as a coating or a liner. In a preferred embodiment the membrane is a coating. The term “coating” is used herein to refer to the membrane.

In addition to the FIBC coating's traditional purpose of making the fabric impermeable to moisture or dust, the coating of the present invention further serves to distribute the static electricity across the surface of the fabric to prevent the creation of islands of conductivity that would otherwise form and act as miniature capacitors.

Furthermore, the coating improves dissipation by creating a large, uniform surface.

Furthermore, the coating serves as the bridge between the conductive channels of PBPC in the fabric and the lifting straps of the FIBC, which can also contain conductive channels of PBPC. The straps in turn serve to ground the FIBC to an external conductor such as a filling machine, fork lift, etc.

An example of PBCP is available under catalog number ARX V 02/159 AT, manufactured by ARGUS Additive Plastics Gmbh of Buren, Germany.

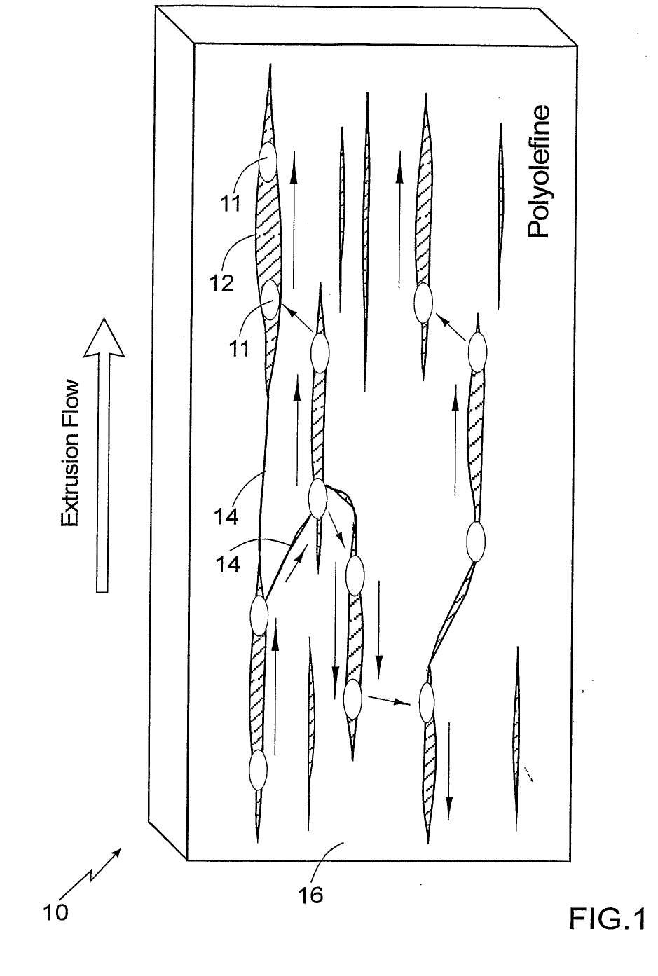

Reference is made to FIG. 1 illustrating a fiber 10 produced in accordance with the present invention. PBPC balls 11 are stretched to form elongated channels 12, some of which are connected or nearly-connected 14. Channels 12 are distributed at, or near, the surface of a matrix of Polyolefine 16, forming fiber 10. Electrical charge flows along Channels 12, an example of the flow is indicated by the arrows in the figure.

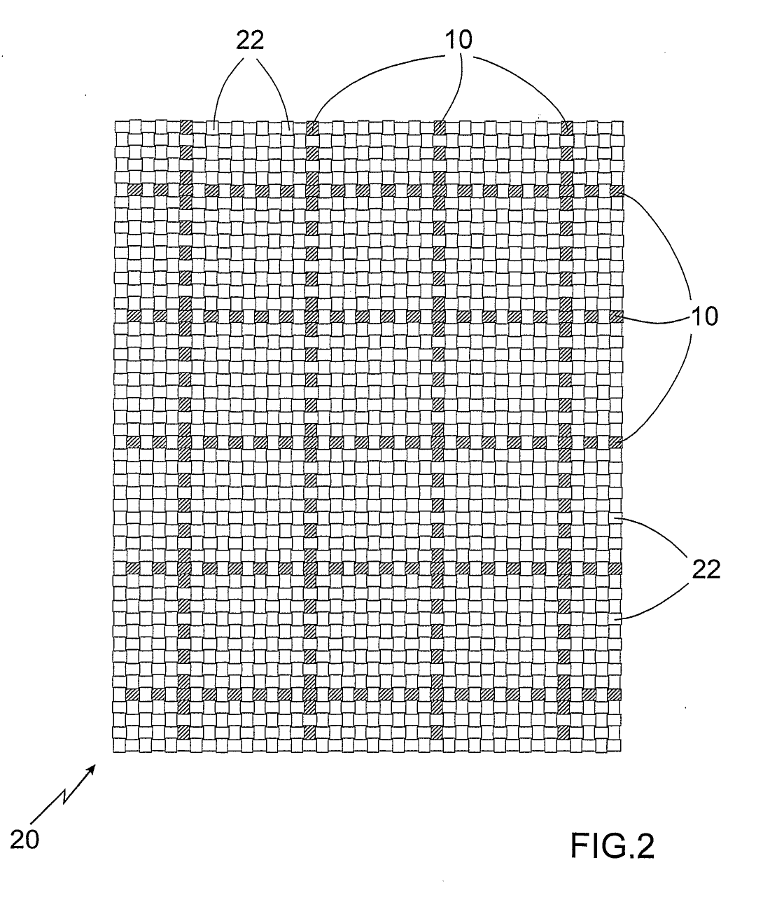

FIG. 2 shows a section of a fabric 20 manufactured according to a preferred embodiment of the present invention. The warp and weft of fabric 20 comprises standard Polyolefine yarns 22 with PBPC fibers 10 of the present invention intersectingly interspersed. PBPC fibers 10 can be aligned with the warp of fabric 20, the weft of fabric 20, or both. The distance between fibers 10 depends on the application. Currently, the CENELEC instruction directs that the area encompassed by the PBPC fiber 10 grid be no less than 20 square cm. It is recommended that the distance between PBPC fibers 10 in the warp and/or the weft can be between 20 mm and 300 mm, preferably between 30 mm to 45 mm.

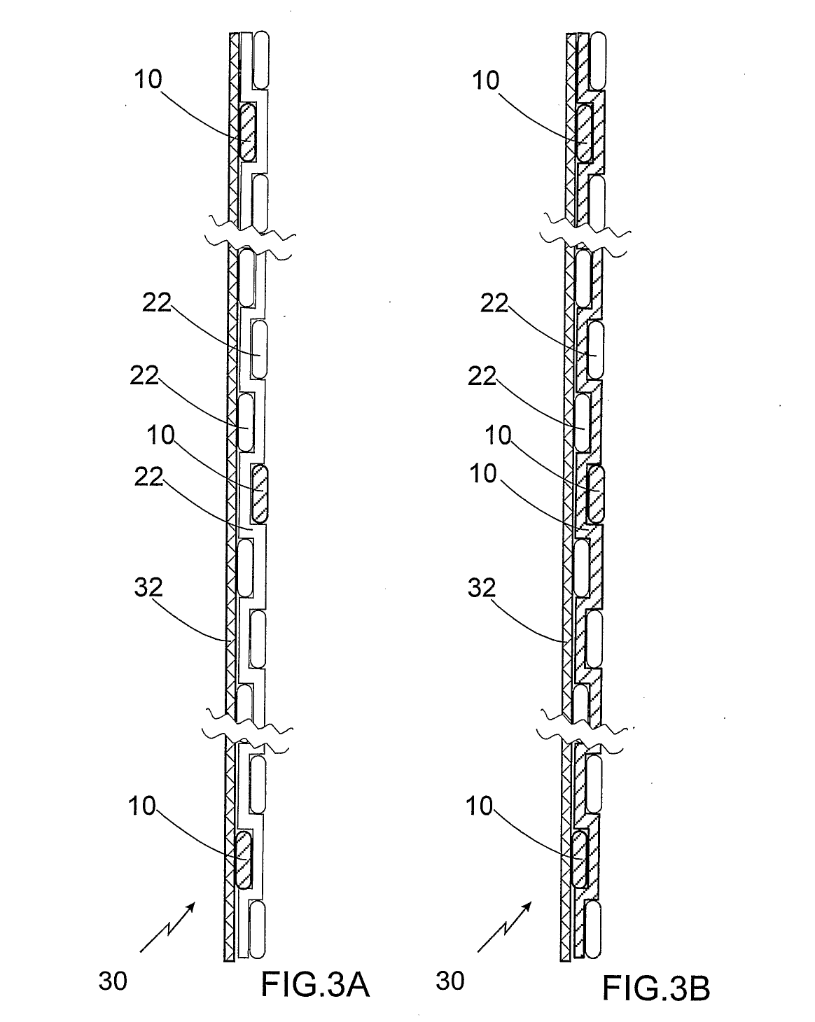

FIG. 3A and FIG. 3B show two cross-section views of coated fabric 30 manufactured according to a preferred embodiment of the present invention. Coated fabric 30 is covered with coating 32, which comprises a similar PBPC mixture to that of PBPC fiber 10. The thickness of coating 32 is typically between 30 micron and 35 micron to comply with the CENELEC instruction. If the coating is thicker than 35 micron, it increases the breakdown voltage beyond 4 kV. If it is thinner than 30 micron, it degrades adhesion.

FIG. 3A shows a cross section view of coated fabric 30 at a point where standard Polyolefine yarn 22 is the warp and most of the weft while PBPC fiber 10 makes up the remaining weft.

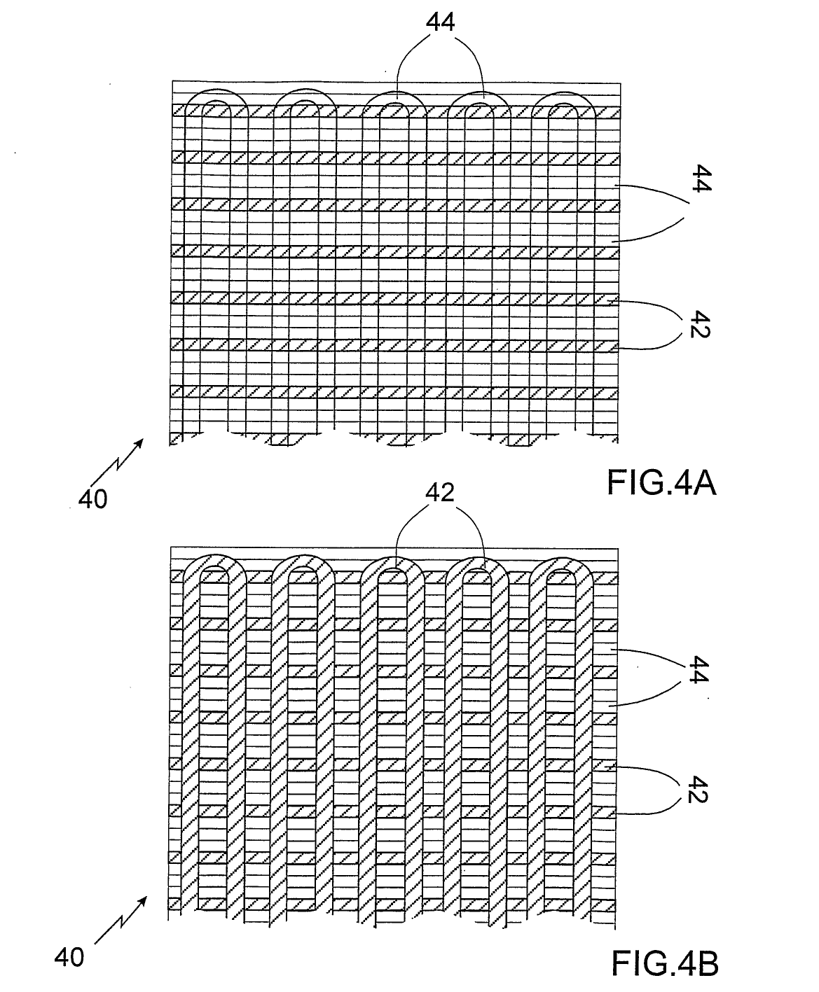

FIG. 3B shows a cross section view of coated fabric 30 at a point where PBPC fiber 10 is the warp and a minor component of the weft (with standard Polyolefine yarn 22 making up the rest of the weft), thereby creating a conductive bridge from the grid to coating 32 FIG. 4A illustrates a lifting strap 40 according to a preferred embodiment of the present invention. Lifting strap 40 can comprise a warp and weft of standard thick Polyolefine yarns 44 (similar in composition to Polyolefine yarn 22 but thicker) with thick PBPC fibers 42 (similar to PBPC fibers 10 but thicker) interspersed in the warp.

FIG. 4B illustrates a lifting strap 40 according to an alternative preferred embodiment of the present invention, wherein thick PBPC fiber 42 is also used in the weft (alone or together with standard thick Polyolefine yarns 44).

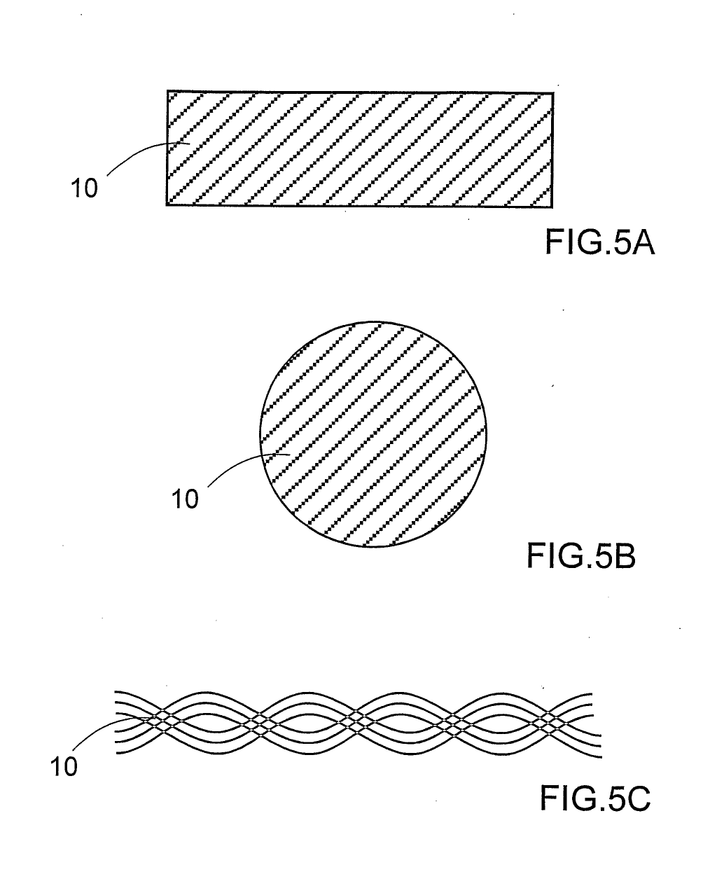

The cross-sections of PBPC fiber 10 or thick PBPC fiber 42 can be various geometries such as, substantially rectangular (FIG. 5A) or substantially round (FIG. 5B). The fiber can be monofilament or it can be multifilament as shown in side view in FIG. 5C. Fibers with different shapes or different quantities of filaments can be used in the same fabric.

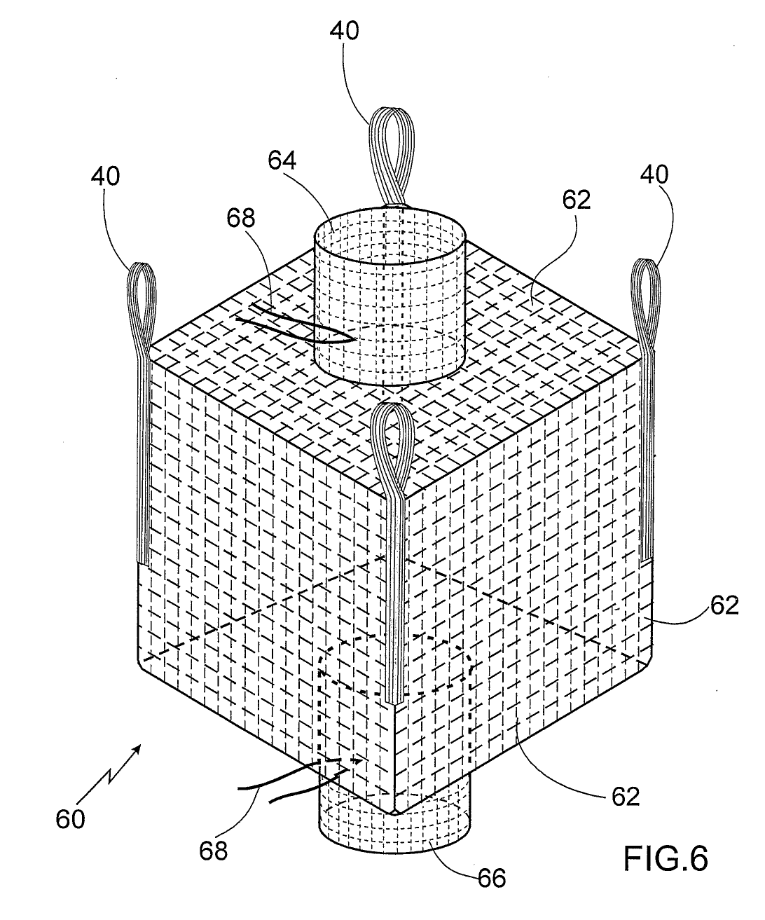

FIG. 6 illustrates a FIBC 60 made from coated fabric 30, which incorporates fiber 10 in accordance with the present invention. FIBC 60 typically has side, top and bottom walls 62. FIBC 40 may be provided with a filling spout 64 and discharge spout 66, each preferably provided with tying strings 68. Lifting straps 40 are connected physically to side walls 62. It is important to make sure that the coating 32 of side walls 62 is in direct physical contact with both walls 62 and straps 40 to enable grounding via straps 40 to an external conductor such as a filling machine, fork lift, etc. Coating 32 can be applied inside or outside of walls 62.

An antistatic liner can be used instead of, or in addition to coating 32. The liner can optionally comprise Polyolefine with a Polyether-Block-Polyolefine-Copolymer added.

It can be seen that the FIBC of present invention differs substantively from the bags of LINQ, EUREA, and SUNJUT.

By comparison with LINQ, the FIBC of the present invention provides interconnected antistatic fibers rather than non-metallic quasi-conductive fibers.

Furthermore, the fabric of the present invention has the added advantage of being easy to manufacture and exhibits great resistance to wear.

Furthermore, the fabric of the present invention has the added advantage that it can be manufactured with a standard cross-section shape.

Furthermore, the fabric of the present invention has the added advantage that it can be manufactured at the optimum diameter for corona discharge.

Furthermore, the FIBC of the present invention has the added advantage that it qualifies as a Type D plus, thereby achieving 100% safety without the need to ground all nearby conductive objects according to CENELEC 50404.

By comparison with EUREA and SUNJUT, the FIBC of the present invention provides a novel antistatic agent comprising balls of copolymer that are elongated during the drawing of the fiber to form connected and nearly-connected conductive channels rather than providing an antistatic web of microcrystalline pins.

Furthermore, the fabric of the present invention has the added advantage of reducing induced energy on surrounding objects enough that those objects do not have to be grounded.

Furthermore, the present invention has the added advantage that the distribution of the antistatic additive in the fibers of the fabric can be controlled, thereby enhancing the antistatic effect.

Furthermore, the present invention has the added advantage that the fabric provides good corona discharge without requiring either the addition of pin-shaped metal particles or that the antistatic threads have a substantially round cross-section and be very thin.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A flexible intermediate bulk container, comprising a flexible bag made of an antistatic fabric comprising electrically non-conducting warp and weft yarns and a plurality of conductive dissipative fibers intersectingly woven into the antistatic fabric, wherein the conductive dissipative fibers comprise Polyolefine with a Polyether-Block-Polyolefine-Copolymer additive, the Polyether-Block-Polyolefine-Copolymer comprising connected or nearly-connected conductive channels at, or near, external surface of the fibers, and wherein the bag is provided with an antistatic dissipative membrane,
whereby the bag may be grounded or ungrounded and exhibit corona discharge.

2. The flexible intermediate bulk container as set forth in claim 1, wherein the Polyether-Block-Polyolefine-Copolymer is mixed into the Polyolefine of the conductive dissipative fibers at a mass portion of 5% to 25%.

3. The flexible intermediate bulk container as set forth in claim 1, wherein at least some of the conductive dissipative fibers have a substantially rectangular cross-section.

4. The flexible intermediate bulk container as set forth in claim 1, wherein at least some of the conductive dissipative fibers have a substantially round cross-section.

5. The flexible intermediate bulk container as set forth in claim 1, wherein at least some of the conductive dissipative fibers are monofilament.

6. The flexible intermediate bulk container as set forth in claim 1, wherein at least some of the conductive dissipative fibers are multifilament.

7. The flexible intermediate bulk container as set forth in claim 1, wherein the membrane comprises a coating.

8. The flexible intermediate bulk container as set forth in claim 7, wherein the coating comprises Polyolefine with a Polyether-Block-Polyolefine-Copolymer additive.

9. The flexible intermediate bulk container as set forth in claim 1, wherein the membrane comprises an antistatic liner provided within the bag.

10. The flexible intermediate bulk container as set forth in claim 9, wherein the antistatic liner comprises Polyolefine with a Polyether-Block-Polyolefine-Copolymer additive.

11. The flexible intermediate bulk container as set forth in claim 1, wherein the membrane is inside the bag.

12. The flexible intermediate bulk container as set forth in claim 1, wherein the at least some conductive dissipative fibers are aligned with the weft.

13. The flexible intermediate bulk container as set forth in claim 12, wherein the distance between at least some conductive dissipative fibers is between 20 mm and 300 mm.

14. The flexible intermediate bulk container as set forth in claim 13, wherein said distance is between 30 mm to 45 mm.

15. The flexible intermediate bulk container as set forth in claim 1, wherein the at least some conductive dissipative fibers are aligned with the warp.

16. The flexible intermediate bulk container as set forth in claim 15, wherein the distance between said at least some conductive dissipative fibers is between 20 mm and 300 mm.

17. The flexible intermediate bulk container as set forth in claim 16, wherein the distance is between 30 mm to 45 mm.

18. The flexible intermediate bulk container as set forth in claim 1, further comprises. lifting straps attached to the bag.

19. The flexible intermediate bulk container as set forth in claim 18, wherein the lifting straps are conductively attached to the bag.

20. The flexible intermediate bulk container as set forth in claim 19, wherein the lifting straps comprise electrically non-conducting warp and weft yarns and a plurality of conductive dissipative fibers.

21. The flexible intermediate bulk container as set forth in claim 20, wherein the conductive dissipative fibers comprise Polyolefine with a Polyether-Block-Polyolefine-Copolymer additive.

22. The flexible intermediate bulk container as set forth in claim 21, wherein the conductive dissipative fibers are multifilament.

23. A flexible intermediate bulk container substantially as described in the present specification accompanying drawings and appending claims.
